(19) United States
(12) Patent Application Publication
(10) Pub. No.: US 2007/0027029 A1
(43) Pub. Date: Feb. 1, 2007

(54) Catalyst support, gas storage body and method for producing these

(76) Inventors: Daisuke Kasuya, Tokyo (JP); Masako Yudasaka, Tokyo (JP); Takeshi Azami, Tokyo (JP); Tsutomu Yoshitake, Tokyo (JP); Yoshimi Kubo, Tokyo (JP); Sumio Iijima, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/558,979

(22) PCT Filed: May 26, 2004
(86) PCT No.: PCT/JP04/07166

§ 371 Date: Dec. 2, 2005

(30) Foreign Application Priority Data
Jun. 2, 2003 (JP) 2003-156219

(51) Int. Cl. B01J 21/18

(52) U.S. Cl. 502/180; 502/185; 502/526

(57) ABSTRACT

Plural carbon nanohorn aggregates are mechanically mixed, and catalysts are supported on surfaces of the mixed carbon nanohorn aggregates. Alternatively gas is adsorbed on the surfaces of the mixed carbon nanohorn aggregates.

### TECHNICAL FIELD

The present invention relates to a catalyst supporting body, a gas storage body, and producing methods thereof.

### BACKGROUND ART

Recently, technological application of nanocarbon is actively studied. The nanocarbon means a carbon substance having a nanoscale fine structure, typified by a carbon nanotube, a carbon nanohorn, and the like. Among others, the carbon nanohorn has a tubular structure in which one end of the carbon nanotube formed by a cylindrically rounded graphite sheet is formed in a circular conic shape. Usually a carbon nanohorn aggregate is formed by aggregation of the carbon nanohorns in a form in which the circular conic portion is projected from a surface like a horn while the tube is located in the center by Van der Waals force acting between circular conic portions. The carbon nanohorn aggregate is expected to be applied to various technical fields due to specific characteristics thereof.

For example, there is proposed a technology in which the carbon nanohorn aggregate is used as an adsorbent (Patent Document 1). According to Patent Document 1, the carbon nanohorn aggregate is produced by a laser vaporization method of irradiating a carbon substance (hereinafter also referred to as “graphite target”) of a raw material with a carbon dioxide gas laser beam in an inert gas atmosphere. The carbon nanohorn aggregate obtained by the method described in Patent Document 1 is a single-wall carbon nanohorn aggregate (hereinafter also referred to as “SWNH assembly”). It is described that the obtained SWNH assembly can be used as a gas adsorbent or a catalyst carrier.

In Patent Document 2, the method of heating the SWNH assembly at about 400 degrees C. in an oxygen atmosphere is proposed as the method of increasing a specific surface area of the SWNH assembly which is used as the adsorbent. Pores are made in the surface of a single-wall carbon nanohorn (hereinafter also referred to as “SWNH”) constituting the SWNH assembly by this oxidation treatment. Conventionally, in order to make the pores in the surface of the carbon nanohorn aggregate, it is necessary to perform the treatment at a high temperature of about 1000 degrees C. However, according to the method, the pores can securely be made in the surface of the carbon nanohorn aggregate to increase the specific surface area while the heating temperature is decreased.

Although the method described in Patent Document 2 is effective in increasing the surface area of the carbon nanohorn aggregate, there is still room for improvement from a viewpoint of a yield of the post-treatment carbon nanohorn aggregate.

[Patent Document 1] Japanese Laid-open patent publication NO. 2002-159851

[Patent Document 1] Japanese Laid-open patent publication NO. 2002-326032

### DISCLOSURE OF THE INVENTION

The present invention is performed in view of the forgoing circumstances, an object of the invention is to provide a technology to simply obtain a catalyst supporting body or a gas storage body, in which the carbon nanohorn aggregate is used, at high yield.

According to the invention there is provided a catalyst supporting body having a carbon nanohorn aggregate whose specific surface area is not less than 400 m²/g and a catalyst supported on a surface of the carbon nanohorn aggregate. According to the above-described Patent Document 2, the specific surface area of the carbon nanohorn aggregate is 308 m²/g. On the other hand, in the carbon nanohorn aggregate which is the carrier of the catalyst supporting body according to the invention, the specific surface area is increased by a predetermined treatment. Therefore, the surface area of the carrier for supporting the catalyst can be increased.

Specifically, for example, the specific surface area of the carbon nanohorn aggregate can be set not less than 400 m²/g. Such carbon nanohorn aggregate supports the catalyst, which sufficiently secures the supported amount of catalyst. Further, the aggregation between the catalysts supported on the surface of the carbon nanohorn aggregate can be suppressed. Therefore, the specific surface area of the supported catalyst is increased, which allows a field of a catalyst reaction to be preferably secured.

For example, the catalyst is supported on the surface of the carbon nanohorn aggregate by impregnation to produce the catalyst supporting body, the specific surface area of the carbon nanohorn aggregate being increased by mechanically mixing the carbon nanohorn aggregates. Further, by mechanically mixing the carbon nanohorn aggregate and the catalyst, not only the specific surface area of the carbon nanohorn aggregate can be increased but also the catalyst can be supported.

According to the invention, there is provided a gas storage body including a carbon nanohorn aggregate, a bonding substance provided on a surface of the carbon nanohorn aggregate, and an adsorbed gas adsorbed on a surface of the bonding substance. In the invention, the bonding substance means the substance which can be adsorbed onto the carbon nanohorn aggregate and the substance on which the adsorbed gas can be adsorbed. Since the gas storage body of the invention has the bonding substance on the surface of the carbon nanohorn aggregate, the adsorbed gas can stably be adsorbed. Also, the adsorbed amount of the adsorbed gas can sufficiently be secured.

According to the invention, there is provided a method of producing a catalyst supporting body, wherein a plurality of the carbon nanohorn aggregates is mixed mechanically and a catalyst is supported on surfaces of the mixed carbon nanohorn aggregates.

According to the invention, there is provided a method of producing a gas storage body, wherein a plurality of carbon nanohorn aggregates is mixed mechanically, the mixed carbon nanohorn aggregates is exposed to an atmosphere including an adsorbed gas and having a pressure higher than an atmospheric pressure, and the adsorbed gas is adsorbed to surfaces of the carbon nanohorn aggregates.

In the producing method of the invention, the plurality of the carbon nanohorn aggregates is mechanically mixed. In the invention, “mechanically mixing” means that the plurality of the carbon nanohorn aggregates is mixed to cause the assemblies to collide with one another or grind the surfaces of the assemblies. The surfaces of the carbon nanohorn aggregates are ground by mechanically mixing the plurality of the carbon nanohorn aggregates, which allows the pores to be made in the surface of the carbon nanohorn constituting the carbon nanohorn aggregate. The outside and inside of the carbon nanohorn can be communicated by the pores, so that the specific surface area of the carbon nanohorn aggregate can be increased.

Accordingly, when the catalyst is supported while the carbon nanohorn aggregate to which the mechanical treatment is performed is used as the carrier, the catalyst can also be supported inside the carbon nanohorn. Therefore, the supported amount of the catalyst can be improved. When the gas is adsorbed by the carbon nanohorn aggregate to which the mechanical treatment is performed, the gas can be adsorbed not only on the outer surface but also on the inner surface of the carbon nanohorn aggregate, so that the gas adsorption amount of the carbon nanohorn constituting the carbon nanohorn aggregate can be increased.

In the producing method of the invention, since the carbon nanohorn aggregates are mechanically mixed one another, the carbon nanohorn aggregates is ground and tip ends of the carbon nanohorns constituting the carbon nanohorn aggregate are bent or deformed. Therefore, an outline of the aggregate formed by the carbon nanohorns can be changed. Further, the carbon nanohorn aggregates can aggregate by grinding the carbon nanohorn aggregates. The pore which becomes a void is made between the carbon nanohorns constituting the carbon nanohorn aggregate by the aggregation of the carbon nanohorn aggregates whose outlines are changed, which allows a void volume being able to be effectively used as the catalyst supporting body or the gas storage body to be increased. Accordingly, the specific surface area of the carbon nanohorn aggregate can be increased.

In the method of producing the catalyst supporting body of the invention, the catalysts may be supported on the surfaces of the carbon nanohorn aggregates while the plurality of the carbon nanohorn aggregates is mixed. In a method of producing a gas storage body of the invention, the adsorbed gas may be adsorbed on the surfaces of the carbon nanohorn aggregates while the plurality of the carbon nanohorn aggregates is mixed.

In the catalyst supporting body of the invention, the catalyst may be a platinum group element or an alloy thereof. In the method of producing the catalyst supporting body of the invention, the catalyst may include a platinum group element or an alloy thereof. Therefore, the catalyst supporting body of the invention can be suitably used as an electrode material for a fuel cell.

In the method of producing the gas storage body of the invention, the adsorbed gas may be hydrogen or methane. Therefore, the gas storage body of the invention can be suitably used as an energy storage body.

In the method of producing the gas storage body of the invention, the adsorbed gas may be adsorbed after a bonding substance is adsorbed on the surfaces of the carbon nanohorn aggregate. The adsorbed gas can stably be adsorbed on the surface of the carbon nanohorn aggregate by causing the bonding substance to be adsorbed on the surface of the carbon nanohorn aggregate. In the invention, the bonding substance may be the substance whose affinity for the adsorbed gas is larger than that of the carbon nanohorn aggregate. Therefore, even if the gas doesn't have a large affinity for the carbon nanohorn aggregate, the gas can securely be adsorbed on the surfaces of the carbon nanohorn aggregate through the bonding substance. Accordingly, the adsorbed amount of the adsorbed gas can further be increased.

In the method of producing the catalyst supporting body of the invention, oxidation treatment may be performed to the carbon nanohorn aggregate. In the method of producing the gas storage body of the invention, oxidation treatment may be performed to the carbon nanohorn aggregate. Therefore, the pores can be made more securely in the surface of the carbon nanohorn constituting the carbon nanohorn aggregate, which allows the surface area of the carbon nanohorn aggregate to be securely increased. As a result, the supported amount of the catalyst or the adsorbed amount of the gas can be increased.

In the method of producing the catalyst supporting body of the invention, the oxidation treatment may be performed to the carbon nanohorn aggregates while the plurality of the carbon nanohorn aggregates is mixed. In the method of producing the gas storage body of the invention, the oxidation treatment may be performed to the carbon nanohorn aggregates while the plurality of the carbon nanohorn aggregates is mixed. Therefore, the pores can be made more efficiently in the surface of the carbon nanohorn.

In the method of producing the catalyst supporting body of the invention, the plurality of the carbon nanohorn aggregates may be mixed with an automatic mortar or a ball mill. In the method of producing the gas storage body of the invention, the plurality of the carbon nanohorn aggregates may be mixed with an automatic mortar or a ball mill. Therefore, the surface area of the carbon nanohorn aggregate can securely be increased, which allows the supported amount of the catalyst or the adsorbed amount of the gas to be further increased.

In the method of producing the catalyst supporting body of the invention, the carbon nanohorn aggregate may be a single-wall carbon nanohorn aggregate or a double-wall carbon nanohorn aggregate. In the method of producing the gas storage body of the invention, the carbon nanohorn aggregate may be a single-wall carbon nanohorn aggregate or a double-wall carbon nanohorn aggregate. Therefore, when the plurality of the carbon nanohorn aggregates is mechanically mixed, the pores can securely be made in surfaces of the carbon nanohorns constituting the carbon nanohorn aggregate. Accordingly, the surface area of the carbon nanohorn aggregate can preferably be increased. In the specification, the double-wall carbon nanohorn aggregate means the carbon nanohorn aggregate which mainly includes a double-wall carbon nanohorn as the carbon nanohorn constituting the carbon nanohorn aggregate.

As described above, according to the invention, the catalyst supporting body or the gas storage body, in which the carbon nanohorn aggregate is used, can simply be obtained at high yield by mechanically mixing the carbon nanohorn aggregates.

### BRIEF DISCRIPTION OF THE DRAWINGS

The above and other objects, features, and advantages of the invention will be apparent from the following description of preferred embodiments and appended drawings.

FIG. 1 is a view showing pores made in a carbon nanohorn constituting a carbon nanohorn aggregate according to an embodiment.

FIG. 2 is a view schematically showing a state of change in a process of mixing the carbon nanohorn aggregates in an embodiment.

FIG. 3 is a view schematically showing a configuration of the carbon nanohorn aggregate according to an embodiment.

FIG. 4 is a view showing a cross section of the carbon nanohorn aggregate before a mechanical treatment is performed in Example.

FIG. 5 is a view showing the cross section of the carbon nanohorn aggregate after the mechanical treatment is performed in Example.

FIG. 6 is a view showing the cross section of the carbon nanohorn aggregate after the mechanical treatment is performed in Example.

FIG. 7 is a view showing the cross section of the carbon nanohorn aggregate after the mechanical treatment is performed in Example.

FIG. 8 is a view showing a relationship between a specific surface area and a time in which the mechanical treatment is performed to the carbon nanohorn aggregate in Example.

FIG. 9 is a view schematically showing a configuration of a catalyst supporting body according to an embodiment.

### BEST MODE FOR CARRYING OUT THE INVENTION

Preferred embodiments of a catalyst supporting body and a gas storage body in which a carbon nanohorn aggregate according to the invention is used will be described below.

### First Embodiment

The present embodiment relates to the carbon nanohorn aggregate in which the specific surface area is increased by the mechanical treatment. The carbon nanohorn aggregate of the embodiment can be used as the carrier which constitutes the catalyst supporting body or the gas storage body.

The carbon nanohorn aggregate used in the embodiment is formed by the aggregation of the carbon nanohorns in a spherical shape. As used herein, the spherical shape shall not always mean a proper sphere, but include various shapes such as an elliptical shape and a doughnut shape.

The carbon nanotube constituting the carbon nanohorn aggregate is the tubular structure in which one end of the carbon nanotube has the circular conic shape. The carbon nanohorn aggregate is formed by the aggregation of the carbon nanohorns in a configuration in which the plural circular conic portions are projected to the surface like the horn while the tube is located in the center by the Van der Waals force acting between each circular conic portions. A diameter of the carbon nanohorn aggregate is not more than 120 nm, and typically the diameter ranges from 10 nm to 100 nm, both ends inclusive. In each carbon nanohorn constituting the carbon nanohorn aggregate, the diameter of the tube is about 2 nm, a typical length ranges from 30 nm to 50 nm, both ends inclusive, and an inclination of an axial plane in the circular conic portion is an average of about 20 degrees. Because of the special structure, the carbon nanohorn aggregate has a packing structure whose specific surface area is large.

Usually the carbon nanohorn aggregate can be produced at a room temperature in the inert gas atmosphere of 1.01325×10⁵ Pa by a laser ablation method in which a solid-state carbon elemented substance such as graphite is used as a target. The dimensions of the pore between the spherical particles of the carbon nanohorn aggregate can be controlled by a producing condition in the laser ablation method, the oxidation treatment after the production, and the like. The carbon nanohorns are chemically bonded to one another in the central portion of the carbon nanohorn aggregate. The shape in which the carbon nanotube is rounded like a ‘kemari’ ball is also considered. However, it is not limited by the structures of the central portion of them. Also, the structure in which the central portion is formed in the hollow structure is also considered.

In the carbon nanohorn constituting the carbon nanohorn aggregate, one end which constitutes a tip end may be closed or opened. A circular conic-shaped vertex of one end may be terminated in the round shape. In the case where the circular conic-shaped vertex of one end may be terminated in the round shape in the carbon nanohorn constituting the carbon nanohorn aggregate, the carbon nanohorns radially aggregates while the portion where the vertex is rounded is orientated toward the outside. The carbon nanohorn aggregate may have the pores because a part of the carbon nanohorn structure is incomplete. Further, the carbon nanohorn aggregate may include the carbon nanotube.

The carbon nanohorn constituting the carbon nanohorn aggregate may be the single-wall carbon nanohorn or the multi-wall carbon nanohorn. In the case where the carbon nanohorn constituting the carbon nanohorn aggregate is the multi-wall carbon nanohorn, it is preferable that the multi-wall carbon nanohorn has the small number of walls. For example, it is preferable to form carbon nanohorn aggregate mainly including a double-wall carbon nanohorn (DWNH). Therefore, because the pores can securely be made in the surface of the carbon nanohorn aggregate through the later-mentioned mechanical treatment, the specific surface area can securely be increased. In the later-mentioned mechanical treatment, the pores can be made more securely in the surface of the carbon nanohorn aggregate by using the carbon nanohorn aggregate mainly including the single-wall carbon nanohorn.

Then, the mechanical treatment of the carbon nanohorn aggregate will be described. The mechanical treatment in the embodiment mainly includes an operation of mechanically mixing and grinding the carbon nanohorn aggregates. The specific surface area can be increased by grinding the carbon nanohorn aggregates. The two following reasons why the specific surface area is increased are mainly thought:

(i) the formation of the pore in the surface of the carbon nanohorn constituting the carbon nanohorn aggregate, and

(ii) the aggregation of the carbon nanohorn aggregates.

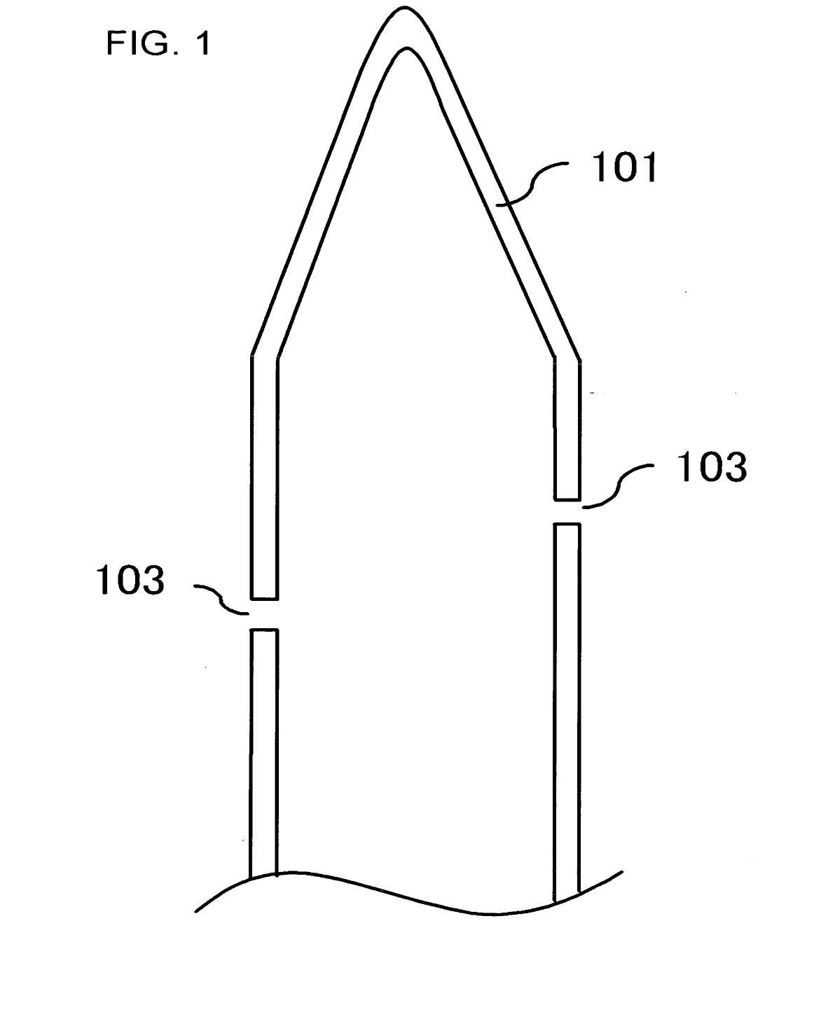

In the case of (i), the pore is made in the surface of the carbon nanohorn constituting the carbon nanohorn aggregate by grinding the carbon nanohorn aggregates in a process of mixing the carbon nanohorn aggregates. FIG. 1 is a view schematically showing a cross section of a single-wall carbon nanotube constituting the single-wall carbon nanohorn aggregate. Referring to FIG. 1, pores 103 are made in the surface of a single-wall carbon nanohorn 101. When the pore 103 is made, since the outer surface and inner surface of the carbon nanohorn 101 are communicated with each other, the surface area of the carbon nanohorn aggregate is increased. Not only the outer surface of the carbon nanohorn but also the inner surface can effectively be utilized.

As described above, conventionally, in order to make the pore 103 in the surface of the carbon nanohorn 101, it is necessary that the oxidation treatment and the like are performed at the high temperature. On the contrary, according to the method of the embodiment, the pore 103 can easily be made in the surface of the carbon nanohorn 101 without exposing the carbon nanohorn aggregate to such the conditions.

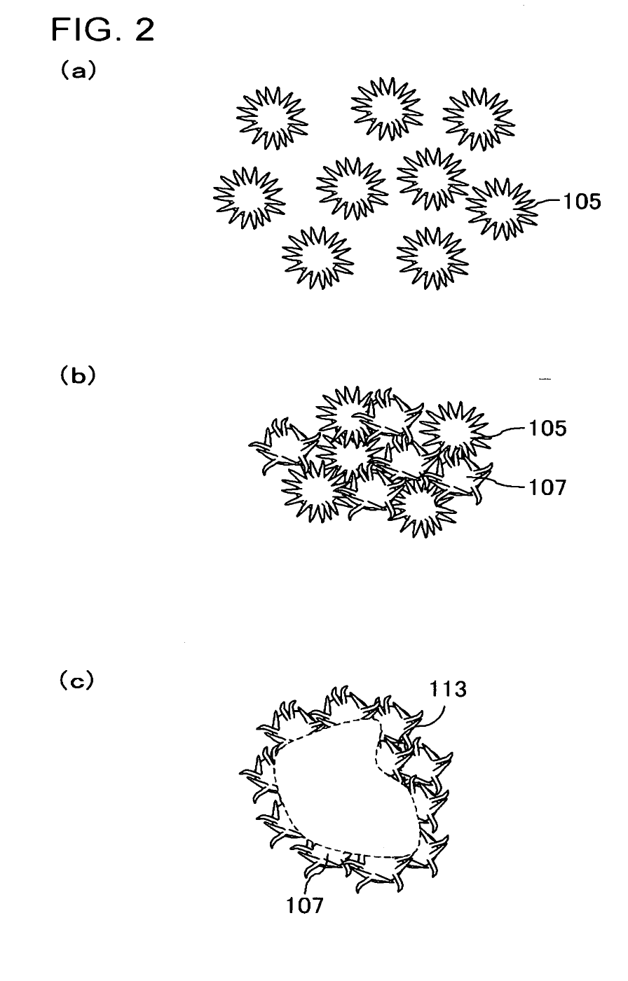

In the case of (ii), the carbon nanohorn aggregates form a secondary aggregate while keeping the state of the assembly by grinding the carbon nanohorn aggregates one another. FIGS. 2(a) to 2(c) are a view schematically showing the state of change in the process of mechanically mixing the carbon nanohorn aggregates. FIG. 2(a) shows carbon nanohorn aggregates 105 before the carbon nanohorn aggregates are ground by the mechanical treatment. Each of the particles schematically shows the carbon nanohorn aggregate 105. When the carbon nanohorn aggregates 105 of FIG. 2(a) are ground, the carbon nanohorn aggregates 105 are deformed by pressing the carbon nanohorn aggregates 105 against one another, the carbon nanohorn aggregates 105 are gradually densely packed (FIG. 2(b)), and the secondary aggregate is formed (FIG. 2(c)).

As mentioned later in Example, the surfaces of the carbon nanohorn aggregates 105 are grounded one another by mixing the carbon nanohorn aggregates 105, the carbon nanohorn 101 constituting the carbon nanohorn aggregate 105 is deformed or the arrangement of the carbon nanohorn 101 is changed. FIG. 2(b) is a view corresponding to the state of the carbon nanohorn aggregates, for example, after the treatment is performed with an automatic mortar for about one hour. Referring to FIG. 2(b), deformed carbon nanohorn aggregates 107 exist and are mixed in the carbon nanohorn aggregates 105 and they exist in the state denser than the state of FIG. 2(a).

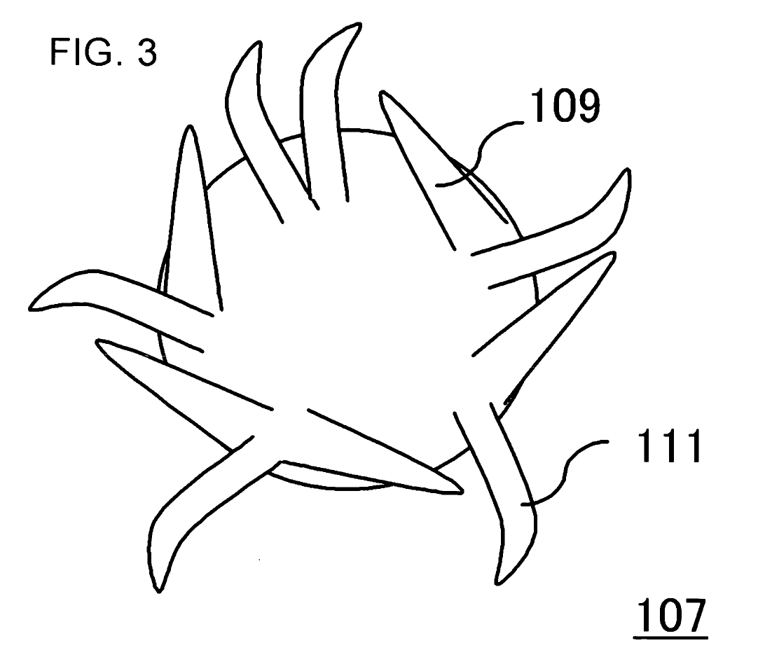

FIG. 3 is a view showing the deformed carbon nanohorn aggregate 107. As shown in the figure, in the carbon nanohorns 101 constituting the deformed carbon nanohorn aggregate 107, some of the tip ends are folded to form carbon nanohorns 111 whose tip ends are bent by grinding the carbon nanohorn aggregates one another. A part of the carbon nanohorns 101 are arranged while laid down on the surface of the carbon nanohorn aggregate, and carbon nanohorns 109 lying on the surface of the carbon nanohorn aggregate are formed.

Returning to FIGS. 2(a) to 2(c), it is thought that the carbon nanohorn aggregate 105 does not disgregate to the many carbon nanohorns 101 by the mechanical mixture, but the arrangement of the effectively be utilized as the pore 113 in FIG. 2(b) or FIG. 2(c).

In the embodiment, since the changes described in (i) and (ii) are generated in the carbon nanohorn aggregate 105 to which the mechanical treatment is performed, the specific surface area is large and the a void capacity which can effectively be utilized is preferably secured. Although the large difference is not perceived between the particle sizes of the carbon nanohorn aggregate 105 and the deformed carbon nanohorn aggregate 107 by the mechanical treatment, the generation of the increase in specific surface area is a unique effect of the invention different from the increase in the specific surface area by simply fining the particle, conventionally considered.

Thus, the deformed carbon nanohorn aggregate 107 and the aggregate thereof, obtained by performing the mechanical treatment to the carbon nanohorn aggregate 105, have the large specific surface area as described above, and can be used as the carrier for the catalyst supporting body or the gas storage body.

The specific surface area of the carbon nanohorn aggregate to which the mechanical treatment is performed can be set, for example, at 400 m²/g, and preferably at 500 m²/g. Therefore, the catalyst supporting amount or the gas adsorption amount can sufficiently be secured.

In the case where it is used as the catalyst supporting body, because the specific surface area thereof is increased when compared with the untreated carbon nanohorn aggregate 105, the surface area where the catalyst can be supported is large. Since the pores 103 are made in the carbon nanohorn 101, the catalyst can be supported carbon nanohorns 101 is changed in the carbon nanohorn aggregate. The tip end of the carbon nanohorn aggregate 105 does not break to generate a small piece of the tip end portion. In the deformed carbon nanohorn aggregate 107, unevenness of the particle surface is lessened and is smoothed. However, the carbon nanohorn aggregate 105 does not largely differ from the deformed carbon nanohorn aggregate 107 in the particle size.

FIG. 2(c) is a view after the carbon nanohorn aggregates 105 are further grounded one another. Referring to FIG. 2(c), the carbon nanohorn aggregate 105 changes the deformed carbon nanohorn aggregate 107. The deformed carbon nanohorn aggregates 107 are closely pressed against one another to become the state packed denser than FIG. 2(b). The deformed carbon nanohorn aggregates 107 aggregate to form the secondary aggregate. In the vicinity of the central portion thereof, as shown by dot lines in the figure, the outline of each deformed carbon nanohorn aggregate 107 becomes unclear. An average particle size of the secondary aggregates is typically about 1 μm.

Thus, while the carbon nanohorn aggregates 105 are independently dispersed in FIG. 2(a), the deformed carbon nanohorn aggregates 107 aggregates in FIG. 2(c). Therefore, the carbon nanohorns 101 are brought densely close to one another to form a pore 113 between the adjacent carbon nanohorns 101. Thus, since the density of the carbon nanohorn 101 is increased by the aggregation of the deformed carbon nanohorn aggregates 107, the void size between the carbon nanohorns 101 can be decreased, and the void between the carbon nanohorns 101 which cannot be utilized in FIG. 2(a) can inside the carbon nanohorn 101. The aggregation between the catalysts supported on the surface of the deformed carbon nanohorn aggregate 107 can be suppressed to secure the dispersibility of the catalyst particles. Therefore, it can preferably be used as the catalyst supporting body of the fuel cell and the like.

In the case where it is used as the gas storage body, since the pores 103 are also made in the surface of the carbon nanohorn 101, the gas can be stored by causing the gas to be adsorbed the inside of the carbon nanohorn 101 as well as on the surface of the carbon nanohorn 101. Therefore, the amount of gas which can be adsorbed is larger compared with the untreated carbon nanohorn aggregate 105. Such gas storage body is preferably used as the energy storage body such as fuel gas and hydrogen gas for the fuel cell, for example. It can also be used as the adsorption body which traps and removes hazardous gas or smelly gas.

Then, the method of producing the deformed carbon nanohorn aggregate 107 will be described. For example, the carbon nanohorn aggregate 105 can be produced at room temperature in the inert gas atmosphere by the laser vaporization method (laser ablation method) in which a solid-state carbon elemented substance such as graphite is used as the target. At this point, the shape of each carbon molecule or the carbon nanohorn 101, the diameter, the length, and the shape of the tip end portion, or a distance between carbon molecules or carbon nanohorns 101 can variously be controlled by producing conditions by the laser ablation method.

In the laser ablation method, the solid-state carbon substance such as rod-shaped sintered carbon or compression molding carbon is irradiated with a laser beam in the inert gas atmosphere to vaporize carbon, and powder in which the spherical substances aggregate is obtained as a soot-like substance. Then, the particles of the carbon nanohorn aggregates 105 can be recovered, in the state of the single carbon nanohorn aggregate or in the state in which the plurality of the carbon nanohorn aggregates is aggregated, by, for example, suspending the powder which is of the obtained soot-like substance in a solvent.

The obtained carbon nanohorn aggregates 105 are mechanically mixed. In the embodiment, the method of mixing carbon nanohorn aggregates 105 is not particularly limited. However, for example, the carbon nanohorn aggregates 105 can be ground by mixing the carbon nanohorn aggregates 105 with the mortar and the pestle. They may be mixed with the automatic mortar. By grinding with the mortar and the pestle or the automatic mortar, preferable frictional force is applied to the surfaces of the carbon nanohorn aggregates 105, which allows the specific surface area to be increased. A grinding time can be set, for example, not less than one hour, and preferably not less than five hours. Therefore, the carbon nanohorn aggregates 105 can securely be packed densely. The grinding time can be set, for example, not more than 50 hours, and preferably not more than 30 hours. Therefore, the specific surface area of the carbon nanohorn aggregates 105 can securely be increased.

In the above descriptions, the method in which the mortar and the pestle are used is shown as an example of the method of grinding the carbon nanohorn aggregates 105. However, the method of grinding the carbon nanohorn aggregates 105 is not limited to the method. For example, a ball mill or a roller can be used.

### Second Embodiment

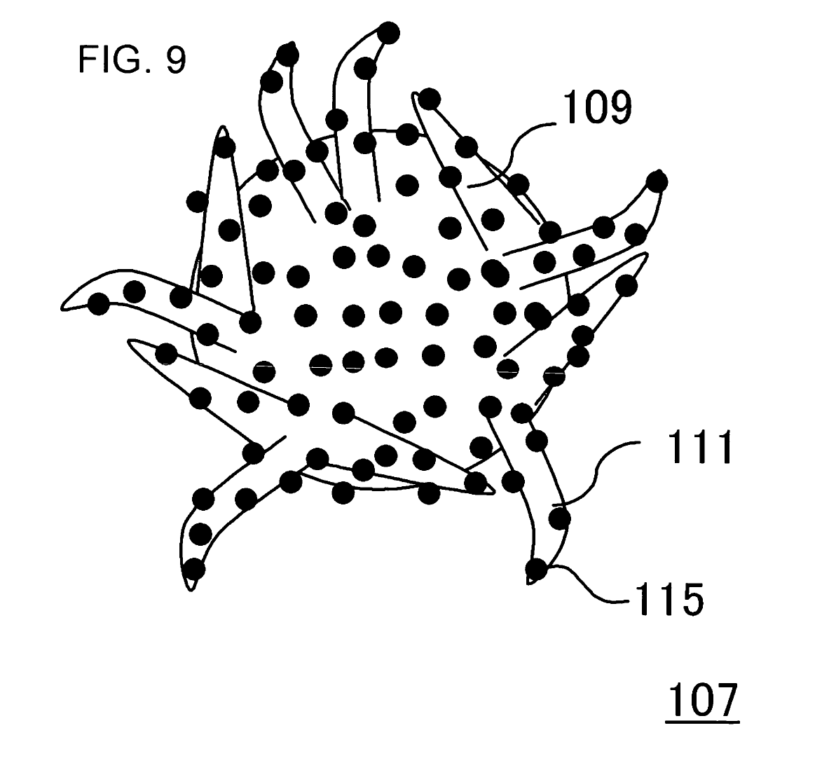

The present embodiment relates to a catalyst supporting body in which the carbon nanohorn aggregate obtained in the first embodiment is used. FIG. 9 is a view schematically showing a catalyst supporting body according to the embodiment. Referring to FIG. 9, catalyst particles 115 are supported on the surface of the deformed carbon nanohorn aggregate 107.

Example of the material for the catalyst particles 115 include platinum, rhodium, palladium, iridium, osmium, rhenium, gold, silver, iron, ruthenium, molybdenum, tin, nickel, cobalt, lithium, strontium, and yttrium, and these materials may be used in a single or a combination of two or more kinds of them. An alloy of two or more kinds of them may be used. It is preferable that the platinum group element or the alloy thereof is used as the catalyst particle 115. In the case where the platinum group element or the alloy thereof is selected and used as the electrode material for the fuel cell, battery characteristics can be improved by using the platinum group element or the alloy thereof.

The catalyst particles 115 can be supported on the deformed carbon nanohorn aggregate 107 by the generally used impregnation method. The impregnation is the method, in which reduction treatment is performed to the catalyst substance after the deformed carbon nanohorn aggregate 107 supports the catalyst substance formed in colloidal by dissolving or dispersing metal salt containing a metal element which becomes the catalyst in the solvent. The average particle size of the catalyst metal supported on the surface of the deformed carbon nanohorn aggregate 107 can be formed not more than 5 nm, for example, the extremely small spherical particle ranging from 1 nm to 3 nm, both ends inclusive, by performing the reduction treatment at a temperature lower than 100 degrees C. including room temperature, for example, at a temperature ranging from 10 degrees C. to 100 degrees C., both ends inclusive. Further, the catalyst particles 115 can uniformly dispersed on the deformed carbon nanohorn aggregate 107.

Thus, in the embodiment, the plurality of the carbon nanohorn aggregates is mechanically mixed, and the catalysts are supported on the surfaces of the mixed carbon nanohorn aggregates. Since the carbon nanohorn aggregate to which the mechanical treatment is performed is used as the carrier, the surface area where the catalyst can be supported is larger when compared with the case in which the untreated carbon nanohorn aggregate is used as the carrier. The dispersion state of the catalyst particles supported on the carrier surface is improved, which allows the aggregation of the catalyst particles to be suppressed. Therefore, the specific surface area of the catalyst born on the surface can be increased.

In the carbon nanohorn aggregate obtained by the method described in the first embodiment, the plurality of the carbon nanohorn aggregates may be aggregated to form the secondary aggregate. Even if the secondary aggregate is formed, an electrolyte can penetrate into the void between the carbon nanohorns in the secondary aggregate. Therefore, in the case where the catalyst is supported on the surface of the secondary aggregate to use the obtained catalyst supporting body as the catalyst electrode of the fuel cell, a so-called three-phase boundary is preferably formed, which allows the specific surface area thereof to be increased.

### Third Embodiment

The present embodiment relates to another method of producing a catalyst supporting body in which the carbon nanohorn aggregate is used. In the embodiment, the catalyst is supported during the carbon nanohorn aggregate treatment process to obtain the catalyst supporting body shown in FIG. 9 in the process of producing the catalyst supporting body by the method described in the first embodiment.

The metals described in the second embodiment and compounds containing these metals can be used as the catalyst. The substance given as the catalyst and the carbon nanohorn aggregate 105 are mixed together at a predetermined ratio, and the mechanical treatment is performed like the first embodiment. The carbon nanohorn aggregates 105 are ground, the pore is made in the surface, the aggregation is generated, the deformed carbon nanohorn aggregates 107 form the secondary aggregate, and also, the fine catalyst particles 115 are supported on the surface of the deformed carbon nanohorn aggregate 107.

Thus, in the embodiment, the catalysts are supported on the surface of the carbon nanohorn aggregate while the plurality of the carbon nanohorn aggregates is mechanically mixed. Because it is not necessary that the process of performing the mechanical treatment to the carbon nanohorn aggregate and the process of supporting the catalyst are performed by separated processes, the catalyst supporting body can be obtained more simply and efficiently

### Fourth Embodiment

The present embodiment relates to the gas storage body, in which the carbon nanohorn aggregate mechanically treated by the method described in the first embodiment is used.

In the embodiment, similarly to the first embodiment, the plurality of the carbon nanohorn aggregates is mechanically mixed, and the mixed carbon nanohorn aggregates adsorb and store the gas. Specifically the deformed carbon nanohorn aggregate 107 or the secondary aggregate thereof, obtained by mechanically mixing the carbon nanohorn aggregates 105, can be used as the carrier for gas adsorption. The gas which is given as the adsorbed substance is not particularly limited. However, specifically examples thereof include H₂, O₂, N₂, CO, CO₂, nitrogen oxides, sulfur oxides, CH₄, SF₆, He, Ne, and the like. When the gas is H₂, He, Ar, N₂, and CH₄, the amount of the gas adsorbed on the surface of the deformed carbon nanohorn aggregate 107 is preferably secured.

In the embodiment, the gas storage body is obtained as follows: First, the plurality of the carbon nanohorn aggregates is mechanically mixed. Then, the mixed carbon nanohorn aggregates are exposed to the atmosphere including the adsorbed gas and having the pressure higher than the atmospheric pressure, the adsorbed gas is adsorbed on the surface of the carbon nanohorn aggregate. Specifically, the deformed carbon nanohorn aggregate 107 is produced like the first embodiment and exposed in the adsorbed substance atmosphere having the high pressure. For example, in the case where hydrogen is adsorbed in the deformed carbon nanohorn aggregate 107, the adsorption can be performed at the pressure ranging from 0.1 MPa to 10 MPa, both ends inclusive at the temperature ranging from −196 degrees C. to 30 degrees C., both ends inclusive.

The gas can be adsorbed on the surface of the deformed carbon nanohorn aggregate 107 and in the pore 103 in the surface by the above method. Further, the adsorbed substance can be introduced into the carbon nanohorn through the pore 103 made in the surface of the deformed carbon nanohorn aggregate 107 and held inside the carbon nanohorn. Therefore, the gas adsorbing amount is larger when compared with the case in which the untreated carbon nanohorn aggregate 105 is used, and it can preferably used as the energy storage body. Specifically, for example, it can be used as a supply body of the fuel gas such as the hydrogen gas in the fuel cell, and also be used as the electrode material of a secondary cell, a heat pump, and the like.

Although the gas is adsorbed in the carbon nanohorn aggregate to which the mechanical treatment is performed is shown in the above descriptions, the substance which can be adsorbed on the surface of the carbon nanohorn aggregate is not limited to the gas. Specifically, for example, organic compounds such as alcohol, aldehyde, ketone, aliphatic hydrocarbon, and aromatic hydrocarbon; complexes such as metal phthalocyanine; organic impurities in contaminated water or contaminated air current; and biological substances and the like are included.

In the embodiment, the gas can also be adsorbed during the process of treating the carbon nanohorn aggregate in the process of producing the gas storage body by the method described in the first embodiment. In this case, the mechanical treatment of the carbon nanohorn aggregate is performed on the conditions that the gas is adsorbed. Specifically, mechanical treatment for the carbon nanohorn aggregate described in the first embodiment is performed in the adsorbed substance atmosphere having the high pressure. The carbon nanohorn aggregates 105 are ground, the pore is made in the surface, the aggregation is generated, and the adsorbed substances are adsorbed on the surface of the deformed carbon nanohorn aggregate 107 while the deformed carbon nanohorn aggregates 107 form the secondary aggregate.

Thus, the adsorbed substance is adsorbed on the surface of the carbon nanohorn aggregate while the plurality of the carbon nanohorn aggregates is mechanically mixed, which allows the mechanical treatment of the carbon nanohorn aggregate and the adsorption of the adsorbed substance to be performed in the same process. Therefore, the gas storage body can be obtained more simply and efficiently.

### Fifth Embodiment

In the fourth embodiment, the adsorbed substance is adsorbed to the carbon nanohorn aggregate to which the mechanical treatment is performed. Alternatively, the adsorbed substance may be adsorbed after the affinity between the surface of the carbon nanohorn aggregate and the adsorbed substance is previously improved.

For example, a method of attaching a bonding substance having an excellent affinity for the adsorbed substance to the surface of the carbon nanohorn aggregate can be used as the method of improving the affinity between the carbon nanohorn aggregate and the adsorbed substance. The bonding substance is appropriately selected according to the kind of the adsorbed substance. For example, carbon materials such as carbon nanotube, nano-fiber, and fullerene and polymers such as an ion-exchange resin can be used.

For example, the gas storage body of the embodiment can be produced by utilizing the method described in the fourth embodiment. Similarly to the fourth embodiment, after the mechanical treatment of the carbon nanohorn aggregate 105 is performed, the bonding substance is attached to the surface of the deformed carbon nanohorn aggregate 107. Then, similarly to the fourth embodiment, the adsorbed substance is adsorbed. The adsorbed substance may directly be adsorbed onto the surface of the carbon nanohorn aggregate 107, or may be adsorbed onto the surface of the bonding substance. The adsorbed substance is adsorbed on the surface (outer surface or inner surface) of the carbon nanohorn aggregate 107 through the bonding substance, which allows the adsorbed substance to be securely and stably held near the surface of the carbon nanohorn aggregate 107. Therefore, the gas storage body having the larger gas adsorption amount can be obtained.

In the embodiment, the bonding substance may be attached to the surface of the carbon nanohorn aggregate during the process of performing the mechanical treatment to the carbon nanohorn aggregate. In this case, for example, when the carbon nanotube is used as the bonding substance to mix the mixture of the carbon nanohorn aggregate 105 and the carbon nanotube like the third embodiment, the carbon nanotube can be attached to the surface of the deformed carbon nanohorn aggregate 107. Then, the adsorbed substance can be bonded as described above.

Chemical modification of the surface of the carbon nanohorn aggregate may be performed as the method of improving the affinity between the carbon nanohorn aggregate and the adsorbed substance. The kind of a functional group introduced to the surface of the carbon nanohorn aggregate can appropriately be selected according to the kind of the adsorbed substance. For example, a COOH group and a CO group and the like can be used.

### Sixth Embodiment

In the above embodiments, the oxidation treatment may be performed at a low temperature prior to the mechanical treatment of the carbon nanohorn aggregate.

The oxidation treatment is performed on such the mild condition that the yield of the carbon nanohorn aggregate is not decreased. For example, it can be performed by heat treatment at the controlled conditions as specifically for the predetermined atmosphere, the treatment temperature, and the treatment time.

Specifically, for example, the heating in the oxidizing atmosphere can be included. It is preferable that the atmosphere in the oxidation treatment is the dry oxidizing atmosphere. The increase in chemical reactivity can be suppressed during temperature elavation by generating the dry oxidizing atmosphere. Further, the treatment temperature can securely be controlled. For example, the dry oxidizing atmosphere can be realized by using the dry oxygen gas or the dry nitrogen gas (inert gas) including about 20% oxygen or the like. The dry oxygen gas and the dry inert gas are one in which moisture in each component gas is removed. For example, generally available various kinds of high-purity gas can be used.

The atmospheric pressure depends on the kind of the used gas. For example, oxygen partial pressure is adjusted in the range of about 0.1 to about 760 Torr. The treatment temperature can be set, for example, not less than 100 degrees C., preferably not less than 200 degrees C. Therefore, the pores can securely be made in the surface of the carbon nanohorn aggregate. The treatment temperature can be set, for example, not more than 500 degrees C., preferably at about 400 degrees C. Therefore, the decrease in yield of the carbon nanohorn aggregate can be suppressed. The treatment time in the oxidation treatment conditions can be adjusted in the range of about 5 to 15 min.

The oxidation treatment method is not limited to the treatment method in the dry oxidizing atmosphere. For example, the carbon nanohorn aggregate can be immersed in an acid solution, such as nitric acid and hydrogen peroxide, having the oxidizing properties. In performing the treatment with the acid solution, it is preferable that the treatment is performed at room temperature without performing the heating. Therefore, the decrease in yield of the carbon nanohorn aggregate can be suppressed.

After the oxidation treatment is performed by these methods, the carbon nanohorn aggregates are mixed and ground by utilizing the method described in the first embodiment. Therefore, the carbon nanohorn aggregates can aggregate one another while the pores are further made in the surface of the carbon nanohorn aggregate, which allows the specific surface area to be further increased.

Thus, the mechanical treatment is performed after the oxidation treatment is performed on the mild condition, which allows the further pores to be made in the surface of the carbon nanohorn aggregate. Therefore, the specific surface area of the carbon nanohorn aggregate can further be increased. The oxidation treatment conditions of the embodiment is mild when compared with the conditions described in the above described Patent Document 2, and the decrease in yield of the carbon nanohorn aggregate due to the oxidation treatment can be suppressed.

The specific surface area of the catalyst particle supported on the surface of the carbon nanohorn aggregate can further be increased by applying the method of the second or third embodiment to the obtained carbon nanohorn aggregate. Therefore, the obtained catalyst supporting body can preferably used for, for example, the catalyst electrodes of the fuel cell and the like.

The gas adsorbing amount to the carbon nanohorn aggregate can further be increased by applying the method described in the fourth or fifth embodiment to the obtained carbon nanohorn aggregate. Therefore, the obtained gas storage body can preferably be used as the further excellent energy storage body specifically for the fuel cell and the like.

### Seventh Embodiment

In the sixth embodiment, the oxidation treatment and the mechanical treatment of the carbon nanohorn aggregate are performed in the separate processes. However, they can also be performed at the same time. The method of simultaneously performing them will be described in the embodiment.

The method described in the first embodiment is used for the mechanical treatment of the carbon nanohorn aggregate. At this point, the mechanical treatment of the carbon nanohorn aggregate is performed under the heating condition in the oxidizing atmosphere, which allows the pores to be further made in the surface thereof during the process of causing the carbon nanohorn aggregates to aggregate by grinding the surfaces of the plurality of the carbon nanohorn aggregates. Therefore, the specific surface area of the carbon nanohorn aggregate can be increased for a shorter time by a simple operation.

The condition of the oxidizing atmosphere and the heating condition can be set, for example, at the conditions described in the fifth embodiment. Therefore, the decrease in yield of the carbon nanohorn aggregate can be suppressed.

In the embodiment, since the oxidation treatment of the carbon nanohorn aggregate is performed while the plurality of the carbon nanohorn aggregates is mechanically mixed, the oxidation treatment and the mechanical treatment can be performed in the same process. Therefore, the specific surface area of the carbon nanohorn aggregate can be increased more efficiently. The obtained carbon nanohorn aggregate can preferably used for the catalyst supporting body or the gas storage body by the same method described in the sixth embodiment.

As described above, the invention is described based on the embodiments. Those skilled in the art will understand that these embodiments are illustrated by way of example only, various modifications could be made, and the modifications are also included in the scope of the invention.

The invention will further be described based on Example. However, the invention is not limited to the following Example.

### EXAMPLE

In Example, the production of the carbon nanohorn aggregate and the mechanical treatment thereof were performed to produce the carrier which can be utilized as the catalyst supporting body or the gas storage body.

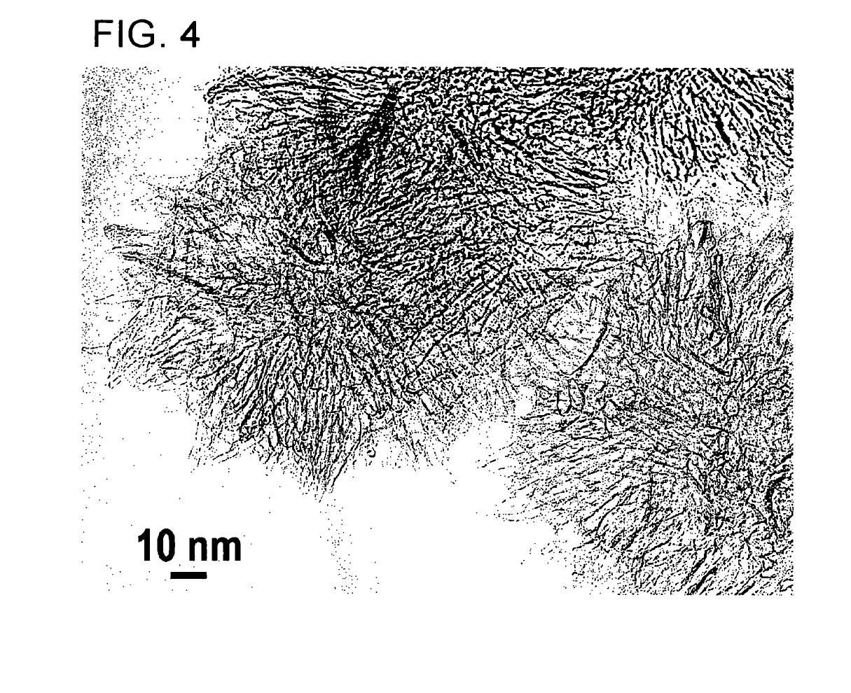

The carbon nanohorn aggregate was produced by the laser ablation method. A rod-shaped sintered carbon which is of the solid-state carbon substance was placed in a vacuum chamber, and the Ar gas was introduced such that the atmospheric pressure became 1.01325×10⁵ Pa after the vacuum chamber was evacuated up to 10⁻² Pa. Then, the solid-state carbon substance was irradiated with a high-output CO₂ laser beam at room temperature for 30 min. A laser output was set at 3 kW, a pulse width was set at 1 second, and a pause width was set at 1 second. In the cross section perpendicular to a lengthwise direction of the rod-shaped sintered carbon, an angle formed between a horizontal plane and a line segment connecting an irradiation position of the laser beam and the circle center, namely, an irradiation angle was set at 45 degrees. Power density was set at 20 kW/cm²±10 kW/cm² in the side face of the rod-shaped sintered carbon. The cross section of the obtained soot-like substance was observed with a transmission electron microscope (TEM). FIG. 4 shows the result. From FIG. 4, it was confirmed that the single-wall carbon nanohorn aggregate was obtained, and the particle size ranged from 10 nm to 100 nm, both ends inclusive.

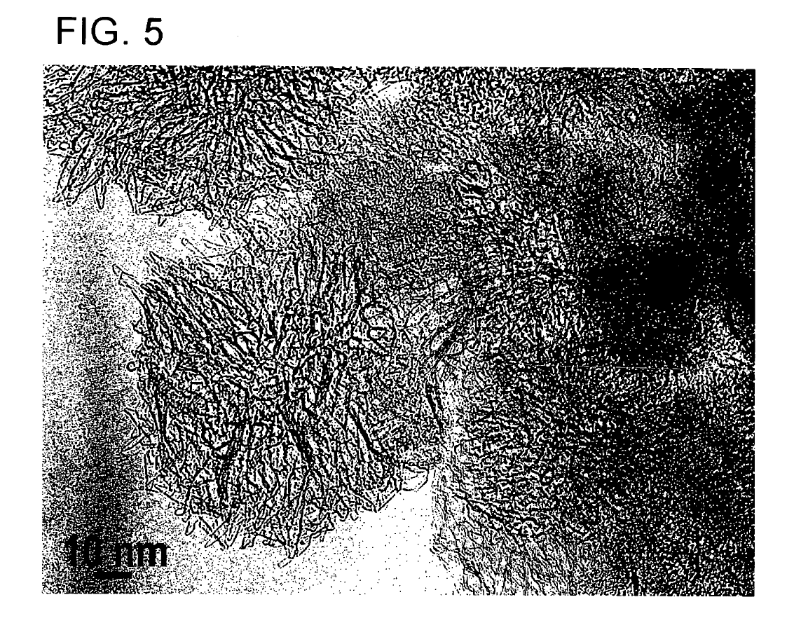

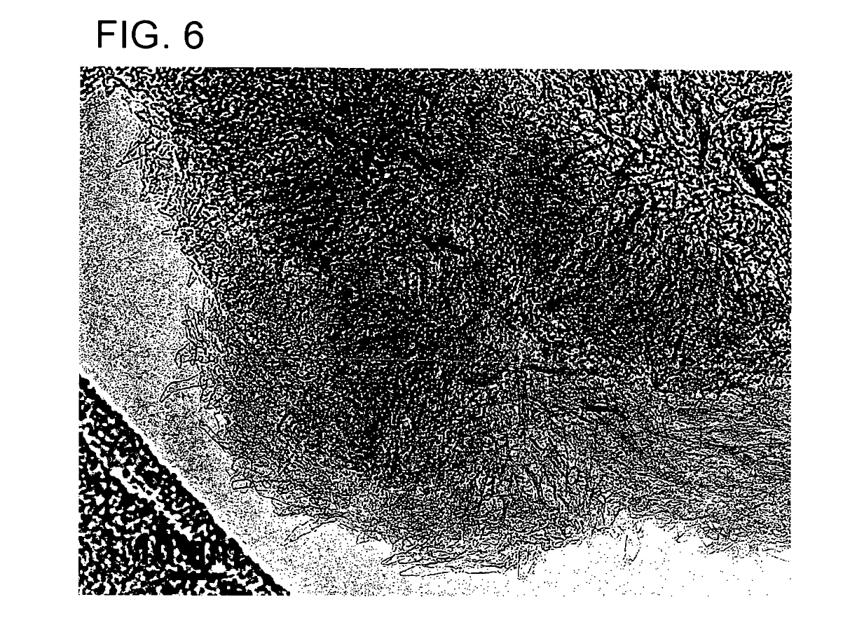

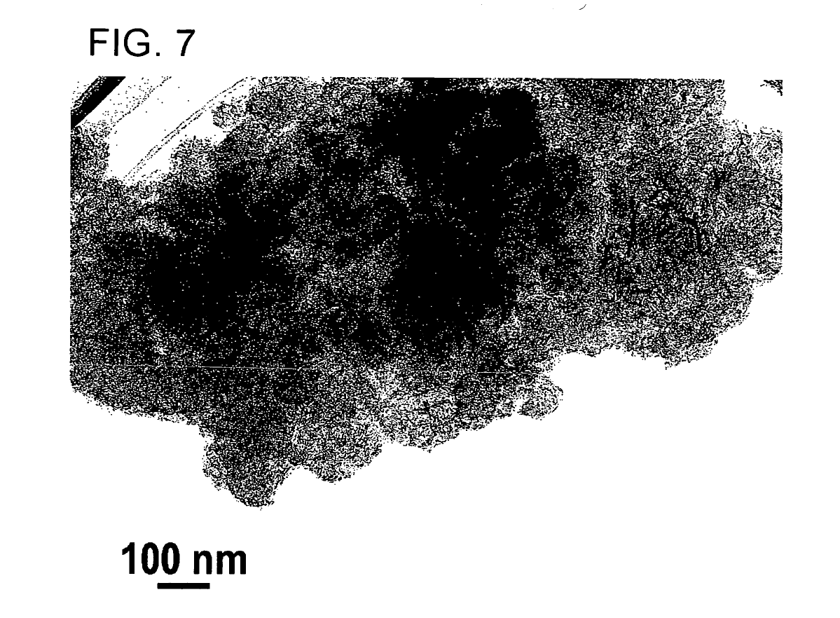

Then, the obtained carbon nanohorn aggregates were mixed for the predetermined time with the automatic mortar (Nitto automatic mortar ANM-1000 series: product of NITTO KAGAKU Co., Ltd). The mixing treatment with the automatic mortar was performed at 25 degrees C. in the air. The cross section of the carbon nanohorn aggregate was observed by TEM after the mixing treatment. FIG. 5 is a view showing a TEM image of the carbon nanohorn aggregate in which the mixing treatment was performed for one hour. FIG. 6 and FIG. 7 are a view showing the TEM image of the carbon nanohorn aggregate in which the mixing treatment was performed for 24 hours. FIG. 6 is an enlarged view of FIG. 7.

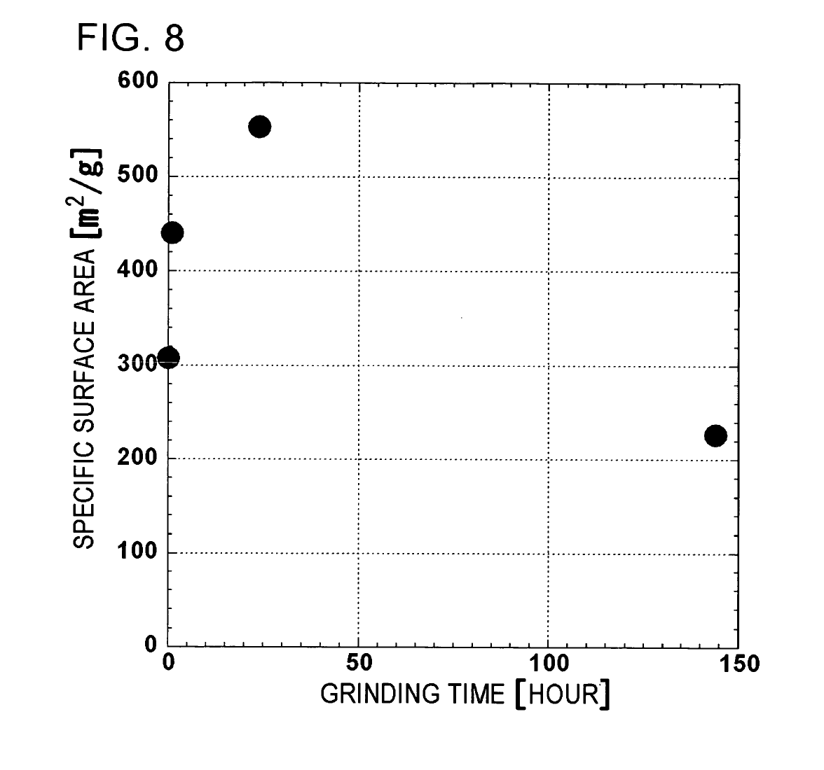

BET specific surface area (JIS Z8830 (2001)) before and after the treatment was measured with a specific surface area measuring apparatus (ASAP2000: product of Shimadzu Corporation) in which nitrogen adsorption is utilized. FIG. 8 shows a relationship between a treatment time and the specific surface area of the carbon nanohorn aggregate.

The following are obtained from the above results. At first, as can be seen from FIG. 4, FIG. 5, and FIG. 6, the tip ends of the carbon nanohorns projected from the surface of the carbon nanohorn aggregate are folded or the arrangement of the carbon nanohorns are changed in the aggregate through the mixing treatment in which the automatic mortar is used. In FIG. 5, the carbon nanohorns are bent or the carbon nanohorns in which the arrangement is changed to lie on the surface of the carbon nanohorn aggregate exist. In FIG. 6, these changes are generated in almost all the carbon nanohorn aggregates. The outline of the surface of the carbon nanohorn aggregate is smoothed by these changes.

Further, as can be seen from FIG. 7, the carbon nanohorn aggregates after 24-hour treatment aggregate to form the secondary aggregate, and the pores are made between the carbon nanohorns. It is not perceived that the particle sizes of the carbon nanohorn aggregates are largely changed before and after the treatment. However, in FIG. 7, the boundaries of the carbon nanohorn aggregates constituting the aggregate become unclear near the central portion of the aggregate. In the sample after the treatment, the carbon nanohorn separated from the carbon nanohorn aggregate or the small pieces generated by the folded tip end of the carbon nanohorn are not observed.

Therefore, it is confirmed that the carbon nanohorn aggregates aggregated each other by mixing the carbon nanohorn aggregates with the automatic mortar. It was clear that the arrangement and structure of the carbon nanohorn constituting each aggregate were changed by the mechanical operation of the grinding.

Then, from FIG. 8, it was confirmed that the specific surface areas of the carbon nanohorn aggregates in which the one-hour and 24-hour treatments were performed were largely increased when compared with the untreated carbon nanohorn aggregate, that is, the carbon nanohorn aggregate in which the treatment time is zero. In the carbon nanohorn aggregate in which the treatment was performed for 144 hours, the surface area was decreased compared with the untreated sample. Therefore, it is find that the long-time treatment is not always good for the treatment to the carbon nanohorn aggregate. When the treatment time is one hour or more and 24 hours or less, it is found that the specific surface area is preferably increased.

1. A catalyst supporting body having a carbon nanohorn aggregate whose specific surface area is not less than 400 m2/g and a catalyst supported on a surface of said carbon nanohorn aggregate.

2. The catalyst supporting body as claimed in claim 1, wherein said catalyst is a platinum group element or an alloy thereof.

3. A gas storage body including a carbon nanohorn aggregate, a bonding substance provided on a surface of said carbon nanohorn aggregate, and an adsorbed gas adsorbed on a surface of said bonding substance.

4. A method of producing a catalyst supporting body, wherein a plurality of carbon nanohorn aggregates is mixed mechanically and a catalyst is supported on surfaces of said mixed carbon nanohorn aggregates.

5. The method of producing a catalyst supporting body as claimed in claim 4, wherein said catalyst is supported on surfaces of said carbon nanohorn aggregates while the plurality of said carbon nanohorn aggregates is mixed mechanically.

6. The method of producing a catalyst supporting body as claimed in claims 4 or 5, wherein said catalyst includes a platinum group element or an alloy thereof.

7. The method of producing the catalyst supporting body as claimed in any one of claims 4 or 5, wherein an oxidation treatment is performed to said carbon nanohorn aggregates.

8. The method of producing the catalyst supporting body as claimed in claim 7, wherein the oxidation treatment is performed to said carbon nanohorn aggregates while the plurality of said carbon nanohorn aggregates is mechanically mixed.

9. The method of producing the catalyst supporting body as claimed in any one of claims 4, 5 or 8, wherein the plurality of said carbon nanohorn aggregates is mixed with an automatic mortar or a ball mill.

10. The method of producing the catalyst supporting body as claimed in any one of claims 4, 5 or 8, wherein said carbon nanohorn aggregate is a single-wall carbon nanohorn aggregate or a double-wall carbon nanohorn aggregate.

11. A method of producing a gas storage body, wherein a plurality of carbon nanohorn aggregates is mixed mechanically, said mixed carbon nanohorn aggregates is exposed to an atmosphere including an adsorbed gas and having a pressure higher than an atmospheric pressure, and said adsorbed gas is adsorbed to surfaces of said carbon nanohorn aggregates.

12. The method of producing the gas storage body as claimed in claim 11, wherein said adsorbed gas is adsorbed on surfaces of said carbon nanohorn aggregates while the plurality of said carbon nanohorn aggregates is mixed mechanically.

13. The method of producing the gas storage body as claimed in claims 11 or 12, wherein said adsorbed gas is hydrogen or methane.

14. The method of producing the gas storage body as claimed in any one of claims 11 or 12, wherein an oxidation treatment is performed to said carbon nanohorn aggregate.

15. The method of producing the gas storage body as claimed in claim 14, wherein the oxidation treatment is performed to said carbon nanohorn aggregates while the plurality of said carbon nanohorn aggregates is mechanically mixed.

16. The method of producing the gas storage body as claimed in any one of claims 11, 12 or 15, wherein said adsorbed gas is adsorbed after a bonding substance is adsorbed on surfaces of said carbon nanohorn aggregates.

17. The method of producing the gas storage body as claimed in any one of claims 11, 12 or 15, wherein the plurality of said carbon nanohorn aggregates is mixed with an automatic mortar or a ball mill.

18. The method of producing the gas storage body as claimed in any one of claims 11, 12 or 15, wherein said carbon nanohorn aggregate is a single-wall carbon nanohorn aggregate or a double-wall carbon nanohorn aggregate.
